(19) United States
(12) Patent Application Publication
(10) Pub. No.: US 2019/0316225 A1
(43) Pub. Date: Oct. 17, 2019

(54) EXTRACTION OF RARE EARTH ELEMENTS AND CARBON RICH SOLIDS FROM COAL FEEDSTOCK USING IONIC LIQUIDS

(71) Applicant: Energy, United States Department of, Washington, DC (US)

(72) Inventors: Chenlin Li, Idaho Falls, ID (US); Ting He, Idaho Falls, ID (US); C. Luke Williams, Idaho Falls, ID (US)

(21) Appl. No.: 15/954,773

(22) Filed: Apr. 17, 2018

(51) Int. Cl. C22B 59/00; B01D 11/02; C10L 5/04; C22B 3/20

(52) U.S. Cl. CPC C22B 59/00; B01D 11/0288; B01D 11/028; C10L 2290/544; C22B 3/20; C10L 2290/06; C10L 5/04

(57) ABSTRACT

Rare earth elements and carbon rich solids are extracted from coal feedstock by combining a coal feedstock with an ionic liquid, forming a mixture. The mixture is heated and a co-solvent is added. Carbon rich solids and rare earth elements are removed from the solution. The ionic liquid and co-solvent may be reused.

### GOVERNMENT INTERESTS

The United States Government has rights in this invention pursuant to Contract No. DE-AC07-05ID14517, between the U.S. Department of Energy (DOE) and Battelle Energy Alliance.

### FIELD OF THE INVENTION

The present invention relates to the extraction of rare earth elements and carbon rich solids from coal feedstock using ionic liquids.

### BACKGROUND OF THE INVENTION

Rare earth elements are critical raw materials in numerous advanced technology applications. As the gap between global demand and supply of rare earth element increases, the search for alternative sources of rare earth elements gains great importance. Recent studies have looked into new mining ventures and recycling rare earth elements from end-user products like magnets and fluorescent lamps. It has been shown that recovering rare earth elements from waste streams will be the most effective and timely approach to address the supply challenge. The current techniques for recovering rare earth elements from waste streams have drawbacks due to the consumption of a significant amount of acids and organic solvents, the production of a high quantity of wastewater, and the complicated process steps involved. Additionally, even though coal feedstocks have been recognized as sources for rare earth element recovery, no process has yet been realized that does not consume a significant amount of acids and organic solvents, does not produce a high quantity of waste water, and is not overly complicated.

### SUMMARY OF THE INVENTION

According to one aspect of the invention, a method to extract rare earth elements and carbon rich solids from coal feedstock that uses ionic liquids. A coal feedstock that has at least one rare earth element is combined with an ionic liquid to form a mixture. The mixture is heated and a co-solvent is added to the heated mixture, producing a solution. Carbon rich solids and dissolved minerals are removed from the solution. The co-solvent, ionic liquid, and at least one rare earth element are separated from the solution.

In another aspect of the invention, a method, as above, to extract rare earth elements and carbon rich solids from a coal feedstock further includes the step of reusing the ionic liquid.

In a further aspect of the invention, a method, as above, to extract rare earth elements and carbon rich solids from a coal feedstock further includes the step of reusing the co-solvent.

### BRIEF DESCRIPTION OF THE DRAWINGS

Embodiments of the present invention are illustrated in the accompanying figures where:

FIG. 1 is a schematic flow diagram illustrating steps in a method according to one embodiment of this invention;

FIG. 2 is a graph showing the results of SEM-EDS data according to one embodiment of this invention; and

FIG. 3 is a graph showing the results of SEM-EDS data according to one embodiment of this invention.

### DETAILED DESCRIPTION OF THE INVENTION

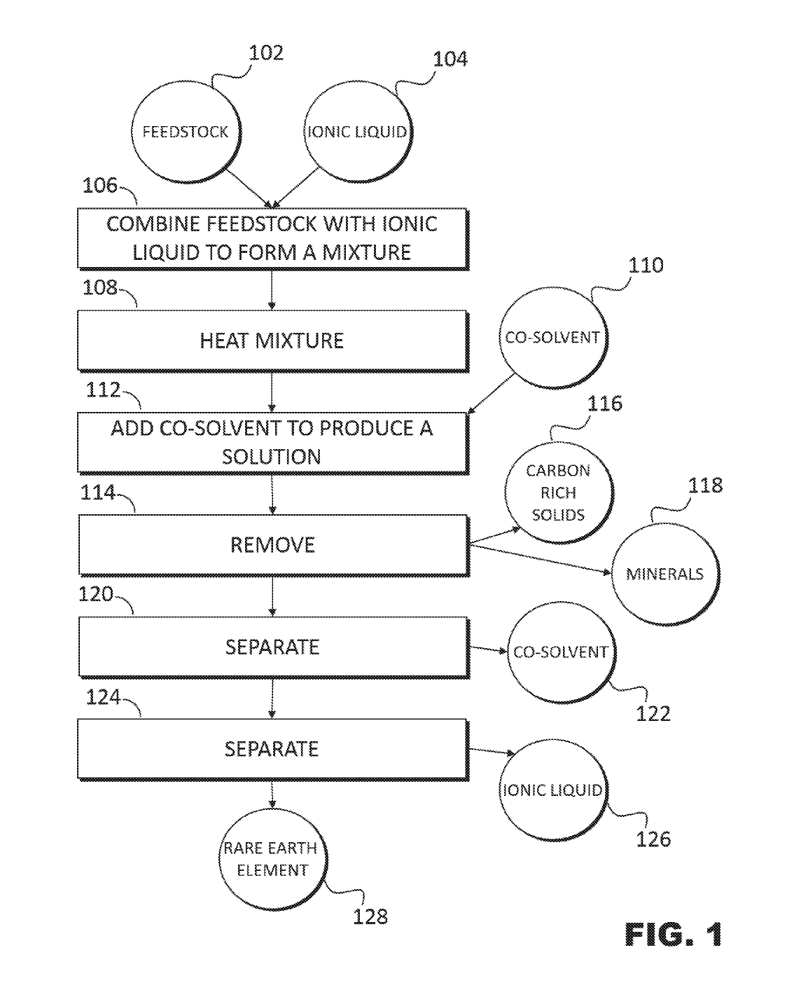

Referring to FIG. 1, a schematic flow diagram illustrating the steps of a method for the extraction of at least one rare earth element and carbon rich solids from coal feedstock using ionic liquids according to one embodiment of the invention is shown. First, a coal feedstock 102 and an ionic liquid 104 are provided. The coal feedstock 102 contains coal, raw coal, coal ash, fly ash, coal byproducts, or a combination therof. The coal feedstock 102 has at least one rare earth element. The at least one rare earth element has, but is not limited to, lanthanum, cerium, praseodymium, neodymium, europium, terbium, dysprosium, holmium, and ytterbium. In alternate embodiments the coal feedstock may have other constituents. The coal feedstock comprises at least approximately 1% by weight of one or more rare earth elements. In alternate embodiments, the coal feedstock may comprise less than approximately 1% by weight of one or more rare earth elements.

The mineral substances contained in the coal feedstock 102 originate from the mineral components of the original coal-forming plants and from the mineral substances accumulated in the coal during all stages of the coalification process. Two types of inorganic compounds may be present within the coal feedstock: one is external in origin, which may be separated from coal; and, the other is integrally linked with organic structures by chemical bonds making its separation from the coal feedstock challenging.

The ionic liquid 104 is a molted salt that exist in liquid formed at a temperature below 100° C. Ionic liquid 104 is composed of a large asymmetric cation, and an organic or inorganic anion. Ionic liquids have special physiochemical characteristics, such as low melting point, non-flammability, and negligible volatility. Additionally, the properties of ionic liquids can be adjusted by changing the constituent anion and cation. Ionic liquids can engage in a wide range of intermolecular interactions, hydrogen bonding, ion-di-pole and dipole-dipole interactions, and π-cation interactions. Being capable of diverse intermolecular interactions facilitates the carbonaceous material dissolution and depolymerization of the present invention. Additionally, unlike substances used in prior art separation techniques, ionic liquids are environmentally friendly because they are environmentally benign.

In step 106, the coal feedstock 102 and ionic liquid 104 are combined, forming a mixture. In one embodiment, the mixture comprises at most approximately 50% by weight solid loading. In alternate embodiments, the mixture comprises at most approximately 25% by weight solid. loading. In yet further embodiments the mixture may comprise more or less than 50% by weight solid loading such that acceptable results are obtained.

The ionic liquid 104 causes the dissolution and deploymerization of coal or coal byproduct by disrupting intermolecular structures and carbon linkages. By using an ionic liquid 104, unlike prior art, an organic acid is not needed to dissolve oxides. Additionally, using an ionic liquid, unlike prior art methods, reduces the coal feedstock coal materials into fine particulates. Reducing the coal feedstock coal materials into fine particulates creates mineral phases and carbon-rich solid stream.

After the coal feedstock 102 and ionic liquid 104 are combined 106, the mixture is heated 108 to a predetermined temperature. In one embodiment, the predetermined temperature is between approximately 25° C. and 200° C. In alternate embodiments the predetermined temperature may be greater than 200° C., as long as acceptable results are obtained. In one embodiment, the heated mixture is incubated for a predetermined time. In an alternate embodiment, the predetermined time is 24 hours.

In step 112, a co-solvent 110 is added to the heated mixture forming a first solution. The co-solvent is water, ethanol, or liquid CO₂. Alternate embodiments may use other co-solvents. Adding 112 the co-solvent 110 extracts unwanted chemicals. Adding 112 the co-solvent 110 may additionally reduce the viscosity of the first solution.

In step 114, carbon rich solids 116 and dissolved minerals 118 are removed 114 from the first solution forming a second solution. Carbon rich solids 116 can include, but are not limited to, solids enriched in carbon and reduced in minerals. Carbon rich solids 116 contain high value chemicals, like asphaltenes. Dissolved minerals 118 can include, but are not limited to, silicone, aluminum, titanium, and iron. Dissolved minerals 118 may include any element native to the feedstock 102. Unlike prior art leaching methods, such as mineral acids, using ionic liquids as solvents and carriers causes limited harm to the reaction system. This will reduce the raw low grade coal materials into fine particulates and separate the organic and mineral phases while producing a carbon-rich solid stream, and a mineral-rich ionic liquid phase that can be further exploited for rare earth element recovery. The carbon-rich phase will provide clean coal feedstock for further conversion into fuels and chemicals. The mineral-rich ionic liquid phase can be further exploited for additional mineral 118 recovery. Electrochemical plating is used for additional mineral 118 recovery. Alternate embodiments may use other techniques for mineral 118 recovery. The minerals 118 recovered are also rare earth elements. The carbon-rich phase can be further exploited by becoming coal feedstock for conversion into fuels and chemicals.

In step 120, a co-solvent 122 is separated from the second solution forming a third solution. Co-solvents can be separated using traditional techniques such as, but not limited to, partitioning or any other technique that provides acceptable results. The co-solvent 122 may be recycled to be reused for the same process or for a different purpose. In one embodiment, high-value chemicals are also separated 120 due to the reduced viscosity of the second solution. High-value chemicals include, but are not limited to, asphaltenes or other poly-aromatic structures.

In step 124, the ionic liquid 126 and at least one rare earth element 128 are separated from the third solution. Rare earth elements 128 can be an element or compound including a rare earth element. Rare earth elements 128 can be a single rare earth element or multiple rare earth elements. The ionic liquid 126 can be separated from the third solution using traditional techniques such as, but not limited to, partitioning. The ionic liquid 126 may be recycled to be reused for the same process or for a different purpose.

In an embodiment, additional carbon rich solids are also separated 124 with the ionic liquid 126 and at least one rare earth element 128. Carbon rich solids include high value chemicals, such as, but not limited to, asphaltenes or other poly-aromatic structures. For example, in an embodiment, upon ionic liquid 126 recovery, the low grade coal valorization will arrive at a closed loop and stable process with high value chemicals and rare earth elements 128. In an embodiment, carbon rich solids can be separated using traditional techniques such as, but not limited to, partitioning.

The rare earth elements from coal within the coal feedstock 102 are in metallic state. Therefore, electrochemical plating can be used to separate rare earth elements from the coal feedstock directly. This is unlike prior art that dissolves oxides in organic acids to create metallic ions for further separation processing.

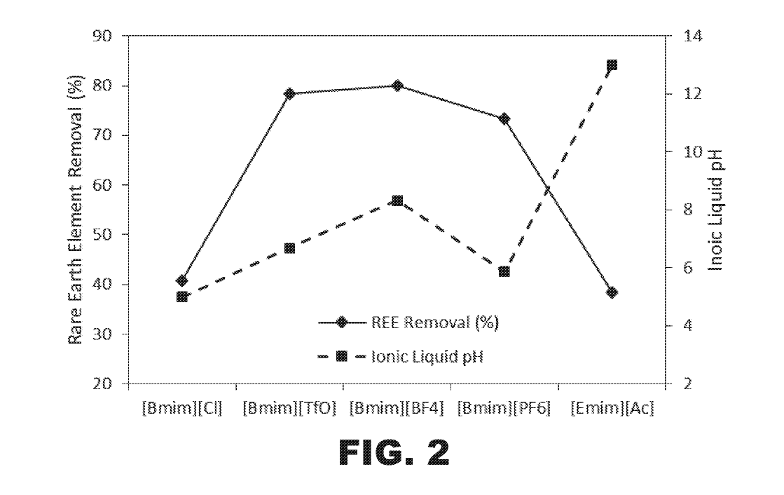

The following experiment was performed to determine if rare earth elements could be removed using an embodiment of the present invention. The ionic liquid was an imidazolium based ionic liquid and selected for coal dissolution and rare earth element extraction. Five ionic liquids were selected: 1-butyl-3-methylimidazolium chloride ([Bmim][Cl]), 1-butyl-3-methylimidazolium trifluoromethanesulfonate ([Bmim][TfO]), 1-butyl-3-methylimidazolium tetrafluoroborate ([Bmim][BF4]), 1-butyl-3methylimidazolium hexafluorophosphate ([Bmim][PF6]), and 1-ethyl-3-methylimidazolium acetate ([Emim][Ac]). The waste product was a sub-bituminous coal and processed at 160° C., 10% solid loading for 3 hours, precipitated, filtered, washed with water, ethanol, and acetone. The recovered solids were carbon-rich and analyzed with scanning electron microscopy—energy dispersive spectroscopy (SEM-EDS). FIG. 2 shows the rare earth element removal percentages from coal samples for five ionic liquids were in the range of 38-80%. The ionic liquids that were less acidic [Bmim][TfO] and [Bmim][PFG] or less basic [Bmim][BF4] showed better performance of 73-80% rare earth element removal. This was much higher than the ionic liquids that were more acidic ([Bmim][Cl], 41%) or more basic ([Emim][Ac], 38%). Results further show the rare earth element distribution, individual and total rare earth element removal of the best ionic liquid performer, [Bmim][BF4]. These semi-quantitative SEM-EDS data, based on analysis of certain microscopic zones in the sample, demonstrated that ionic liquids are efficient solvents for coal dissolution to facilitate the rare earth element separation and extraction.

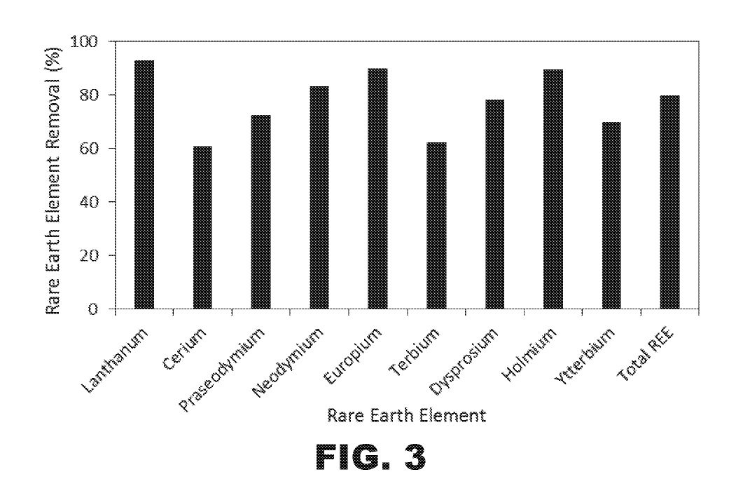

FIG. 3 further illustrates the rare earth element distribution, individual, and total REE removal of the most effective ionic liquid ([Bmim][BF4]) The SEM-EDS provides semi-quantitative data, based on analysis of certain microscopic zones in the sample, and these promising results demonstrated that ILs are efficient solvents for coal dissolution and facilitate REE separation and extraction.

It is to be understood that the above-described arrangements are only illustrative of the application of the principles of the present invention. Numerous modifications and alternative arrangements may be devised by those skilled in the art without departing from the spirit and scope of the present invention and the appended claims are intended to cover such modifications and arrangements.

Any element in a claim that does not explicitly state “means for” performing a specified function, or “step for” performing a specific function, is not to be interpreted as a “means” or “step” clause as specified in 35 U.S.C. § 112, ¶6. In particular, the use of “step of” in the claims herein is not intended to invoke the provisions of 35 U.S.C. § 112, ¶6.

1) A method to extract at least one rare earth element and carbon rich solids from coal feedstock, the method comprising:
providing a coal feedstock, the coal feedstock comprising at least one rare earth element;
providing an ionic liquid;
combining the coal feedstock and the ionic liquid, forming a mixture;
heating the mixture to a predetermined temperature;
adding a co-solvent to the heated mixture, producing a first solution;
removing carbon rich solids and dissolved minerals from the first solution thereby forming a second solution; and
separating the co-solvent, ionic liquid, rare earth elements from the second solution thereby forming a third solution.

2) The method of claim 1, wherein the coal feedstock comprises at most approximately 1% by weight one or more rare earth elements.

3) The method of claim 1, wherein the mixture comprises at most approximately 50% by weight solid loading.

4) The method of claim 1, further including the step of incubating the mixture at a predetermined temperature for a predetermined time.

5) The method of claim 4, wherein the predetermined time is up to 24 hours.

6) The method of claim 1, wherein the step of heating further includes extracting unwanted chemicals from the mixture.

7) The method of claim 1, wherein the coal feedstock is raw coal, a coal byproduct, coal ash, fly ash or a combination thereof.

8) The method of claim 1, wherein the at least one rare earth element is in a metallic state.

9) The method of claim 1, wherein the predetermined temperature ranges between approximately 25° C. and 200° C.

10) The method of claim 1, wherein the co-solvent is water, ethanol, acetone, or liquid CO₂.

11) The method of claim 1, wherein said step of removing dissolved minerals further includes extracting dissolved minerals with electrochemical plating.

12) The method of claim 1, wherein said step of removing carbon rich solids further includes filtering the carbon rich solids.

13) The method of claim 1, wherein carbon rich solids comprise a high value chemical.

14) The method of claim 1, wherein carbon rich solids comprise asphaltenes.

15) A method to extract at least one rare earth element and carbon rich solids from coal feedstock, the method comprising:
providing a coal feedstock, the coal feedstock comprising at least one rare earth element;
providing an ionic liquid;
combining the coal feedstock and the ionic liquid, forming a mixture;
heating the mixture to a predetermined temperature;
adding a co-solvent to the heated mixture, producing a first solution;
removing carbon rich solids and dissolved minerals from the first solution thereby forming a second solution;
separating the co-solvent, ionic liquid, rare earth elements from the second solution thereby forming a third solution; and
reusing the ionic liquid.

16) A method to extract at least one rare earth element and carbon rich solids from coal feedstock, the method comprising:
providing a coal feedstock, the coal feedstock comprising at least one rare earth element;
providing an ionic liquid;
combining the coal feedstock and the ionic liquid, forming a mixture;
heating the mixture to a predetermined temperature;
adding a co-solvent to the heated mixture, producing a first solution;
removing carbon rich solids and dissolved minerals from the first solution thereby forming a second solution;
separating the co-solvent, ionic liquid, rare earth elements from the second solution thereby forming a third solution; and
reusing the co-solvent.
